(19) United States
(12) Patent Application Publication
(10) Pub. No.: US 2024/0268347 A1
(43) Pub. Date: Aug. 15, 2024

(54) Animal Shoe

(71) Applicant: RIFRUF, LLC, Long Island City, NY (US)

(72) Inventors: Peter Liu, Long Island City, NY (US); Jeremy Sung Yoon, Dover, NH (US)

(21) Appl. No.: 18/167,352

(22) Filed: Feb. 10, 2023

(51) Int. Cl. A01K 13/00

(52) U.S. Cl. CPC A01K 13/007

(57) ABSTRACT

An animal shoe comprising an upper having a body with an opening that is configured for receiving a foot of an animal and a multilayer sole. The multilayer sole has a first outsole connected to the body of the upper, the first outsole comprising a bottom, and the first outsole comprising a first material, and a second outsole connected to the body of the upper and the first outsole. The second outsole covers the bottom of the first outsole. The second outsole is made of a second material that is different than the first material of the first outsole.

### BACKGROUND

The present disclosure relates to animal apparel. More specifically, the present disclosure relates to a dog shoe.

A paw of a dog comprises four digital pads, a metacarpal pad located rearwardly of the digital pads, a carpal pad located on the forelimb, four claws, and a dewclaw, which such dewclaws are typically only present on the front paws in most dog breads. A paw of a dog also comprises numerous tiny bones, muscles, ligaments, tendons, and skin. Paws serve a myriad of purposes, including sensory perception and perspiration. Maintaining the health of a dog's paws is absolutely essential for having a happy and healthy dog. Paws can easily be injured by foreign objects, like shards of glass, and/or by especially hot or cold ground temperatures as the dog traverses the ground in daily life routines.

A typical dog shoe includes a sole, a unitary upper connected to the sole, and a fastening mechanism such as a zipper or a hook-and-loop fastener strap. Dog shoes may be overly stiff or far too flexible. If a dog shoe is overly stiff, it may cause discomfort from rubbing or more severely a muscle or ligament tear. If a dog shoe is overly flexible, it may advantageously allow augmented maneuverability however it is likely too thin or too poorly insulated to effectively protect a paw of dog. Thus, a flexible dog shoe is typically an ineffective protective measure. For instance, known waterproof dog shoes are either made of a rigid rubber material or overly soft neoprene such that they are difficult to dawn and doff, ineffective protective measures, and/or they fit poorly which thereby inhibits movement or causes injury.

### SUMMARY

In one exemplary embodiment, there is provided a waterproof dog shoe. The shoe includes an upper with at least two fastening devices and a multilayer sole. The multilayer outsole is made from two differing materials which dually help to waterproof the shoe, disperse the weight of the dog, and protect the dog from foreign objects. The multilayer sole has a foam outsole and a rubber outsole that at least partially covers the foam outsole.

In another exemplary embodiment, there is provided an animal shoe. The animal shoe comprises an upper having a body with an opening that is configured for receiving a foot of an animal and a multilayer sole. The multilayer sole has a first outsole connected to the body of the upper, the first outsole comprising a bottom, and the first outsole comprising a first material, and a second outsole connected to the first outsole. The second outsole covers the bottom of the first outsole. The second outsole comprises a second material that is different than the first material of the first outsole.

In yet another exemplary embodiment, there is provided a dog shoe. The dog shoe comprises an upper comprising a body with an opening that is configured for receiving a paw of a dog. The dog shoe also comprises a strap connected to the upper and configured for holding the upper onto the paw of the dog. The dog shoe also comprises a multilayer sole comprising a first outsole connected to the body of the upper, the first outsole comprising a bottom, and the first outsole comprising a first material, and a second outsole connected to the first outsole. The second outsole covers the bottom of the first outsole. The second outsole comprises a second material different than the first material of the first outsole.

One possible advantage of the exemplary embodiment of the animal shoe is that the multilayer sole prevents water from contacting the upper and also from pooling at the connection point between the upper and the multilayer sole.

Another possible advantage of the exemplary embodiment of the animal shoe is that the upper has two different tightening features which both help to hold the shoe onto the animal and also to maintain a watertight seal.

Yet another possible advantage of the exemplary embodiment of the animal shoe is that the multilayer sole reduces the overall weight of the shoe and increases user comfort.

### BRIEF DESCRIPTION OF THE DRAWINGS

The embodiments illustrated herein are not limited to the precise arrangements, sequential steps, and dimensions shown. Like numerals indicate like elements throughout the drawings. In the drawings:

FIG. 1 illustrates a front perspective view of an embodiment of a dog shoe according to the present disclosure;

FIG. 2 illustrates a front view of the dog shoe;

FIG. 3 illustrates a rear view of the dog shoe;

FIG. 4 illustrates a side view of the dog shoe;

FIG. 5 illustrates a bottom view of the multilayer sole of the dog shoe; and

FIG. 6 illustrates a side view of the multilayer sole of the dog shoe.

### DETAILED DESCRIPTION

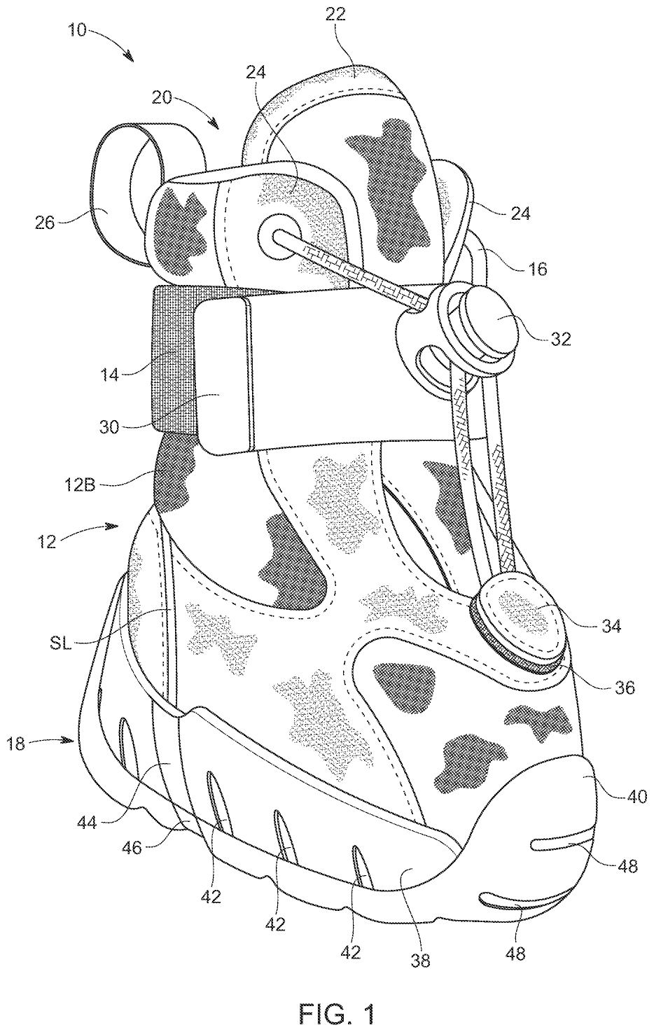

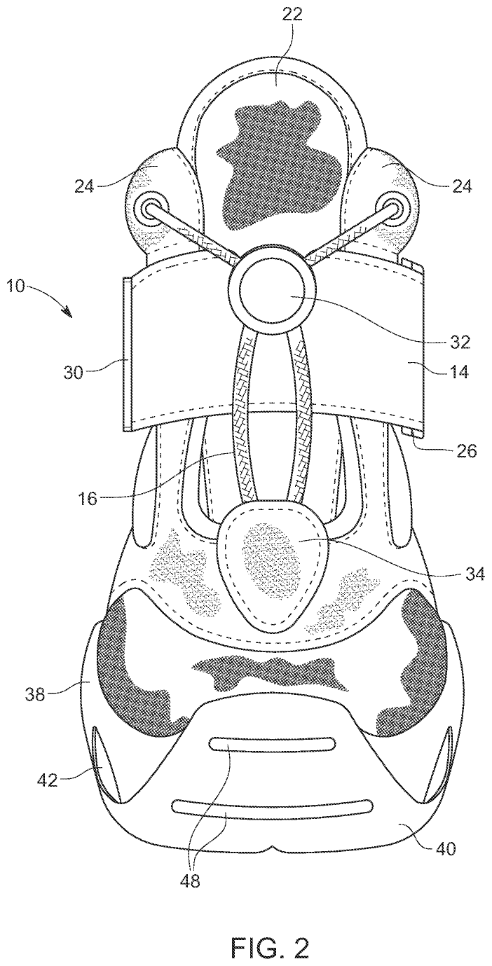

FIGS. 1-6 illustrate an embodiment of an animal shoe 10, or boot, sneaker, foot ware, etc. The shoe 10 can be a waterproof shoe configured for dually protecting the foot of the animal and also preventing water from contacting the foot of the animal. The shoe 10 may be worn by any desired animal, such as a dog, a pig, or a fox. Therein, the shoe 10 may protect the foot, or weight-bearing appendage, of any desired animal. As shown, the shoe 10 is configured for being worn by a dog for protecting the dog's paw. The shoe 10 may also be configured as a waterproof shoe that is configured for water-sealing the dog's paw. The dog shoe 10 generally includes an upper 12, one or more fastening devices 14, 16, and a multilayer sole 18. As discussed in more detail below, the upper 12 and the multilayer sole 18 together may form a watertight seal around the foot of the animal.

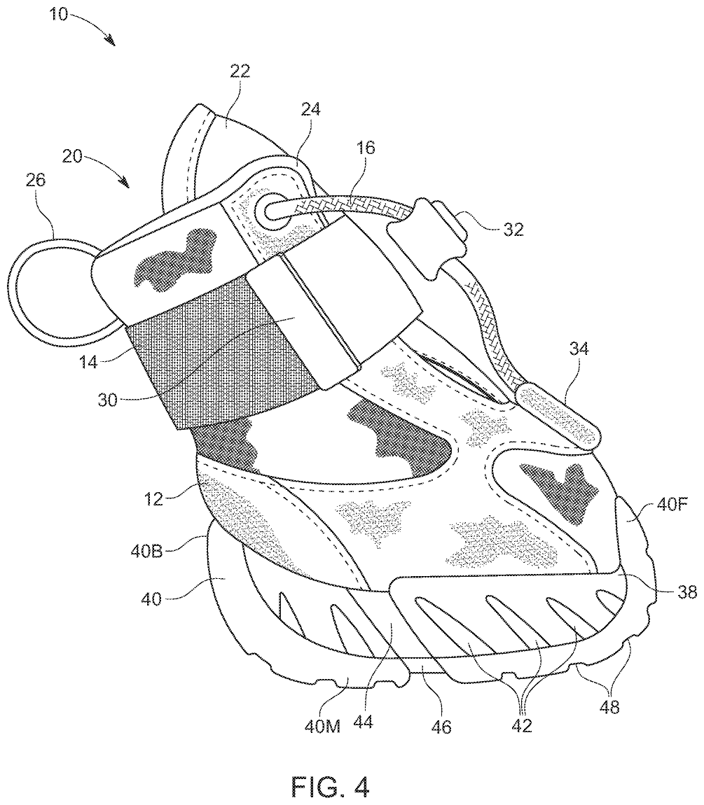

The upper 12 has a body 12B with an opening 20 that is configured for receiving a foot of an animal (FIG. 1). The upper 12 has an ergonomic profile which has a slight angle that corresponds to the angle of the dog's leg and paw (FIG. 4). The upper 12 also includes a tongue 22 located at its front that is configured for widening and/or narrowing the opening 20 of the body 12B in order to more easily don and doff the shoe 10. The tongue 22 may or may not include slots and/or additional material, such as flaps, at its lateral sides which allow it to move relative to the other portions of the body 12B of the upper 12. Thereby, via moving the tongue 22 forwardly and widening the opening 20, the shoe 10 may be easily fit on the dog's paw without catching on or hurting the dog's dewclaw. The upper 12 may further include side members 24 that at least partially extend over the tongue 22. The upper 12 may further include a looped strap 26 which is located at the upper back portion of the body 12B and adjacent to the opening 20.

The upper 12 may comprise one or more materials. For instance, the upper 12 may be made of two differing materials. The upper 12 may include a fabric, a canvas, pleather, leather, synthetic fiber, and/or a polyurethane material. As shown, the upper 12 is made of a fabric material and a synthetic fiber material. The fabric material is stitched onto the synthetic fiber material.

The one or more fastening devices 14, 16 may include a strap 14 and/or a cord 16. For example, the shoe 10 may include a strap 14 and an elastic cord 16 connected to the upper 12. It is conceivable that the shoe 10 may include more than two fastening devices. The fastening devices 14, 16 may help retain and hold the shoe 10 onto the foot of the animal. Additionally, the fastening devices 14, 16 may help to maintain a watertight seal to prevent water from entering the shoe 10, e.g., between the foot of the animal and the inside of the shoe 10.

The strap 14 can be located near the top end of the upper 12, above the centerline of the upper 12. In other words, the strap 14 may be located above the middle of the upper 12. The strap 14 extends over and wraps around the tongue 22 of the upper 12. The strap 14 is configured for applying a first holding force for holding the upper 12 onto the foot of the animal. The strap 14 can be a hook and loop fastener, e.g., Velcro®, strap that wraps around and connects back on itself, thus forming a wraparound strap. The strap 14 may comprise any desired material, such as a synthetic fiber.

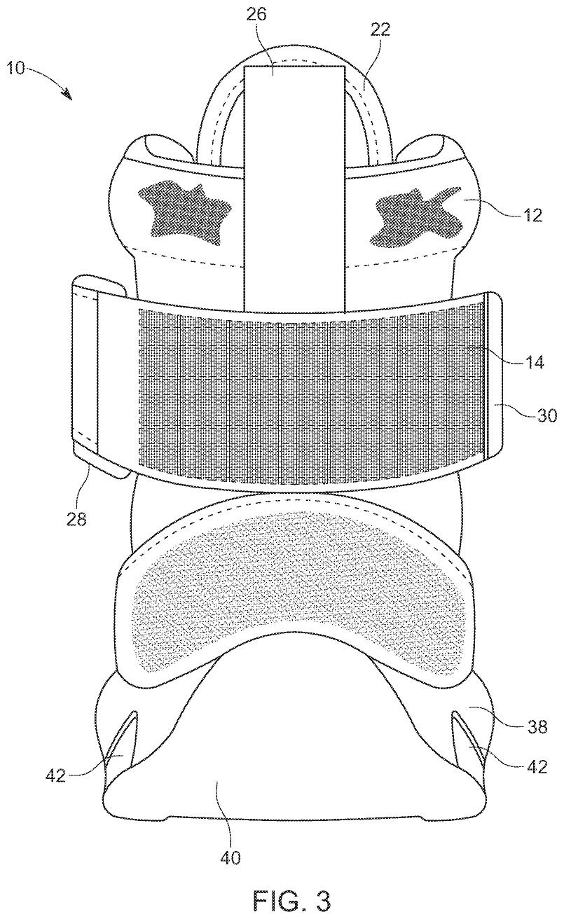

The strap 14 may include a buckle 28 (FIG. 3). It is conceivable that the strap 14 may not include a buckle 28. The strap 14 may or may not include multiple portions. For example, the strap 14 may be a single, continuous strap which is connected to the upper 12 at one location and accordingly wraps around itself to secure onto itself. Alternatively, the strap 14 may include two or more portions wherein one strap portion is connected to the upper 12 at a first location and another strap portion is connected to the upper 12 at a second location. If the strap 14 comprises two or more portions, the strap portions may be connected to one another by way of the buckle 28 such that the fixed strap portion is connected to the buckle 28 and the movable strap portion is threaded through the buckle 28 such that it may loop around and attach to itself.

The strap 14 may additionally have a tab 30 at its distal end for easily gripping the strap 14. The tab 30 may also help protect the strap 14 from water and/or damage from contacting foreign objects. The tab 30 may be made of any desired material, such as an elastomer.

The cord 16 is connected to the upper 12. The cord 16 can be located above the strap, near the top of the upper 12 and adjacent to the opening 20. The cord 16 may at least partially extend within the body 12B of the upper 12. For instance, the cord 16 can be partially fitted within a corresponding internal channel of the upper 12, which has openings and eyelets (unnumbered) therearound for receiving the cord 16. The cord 16 is configured for applying a second holding force for holding the upper 12 onto the foot of the animal. The cord 16 pinches the side members 24 together, i.e., biases them toward one another, which compresses the top of the tongue 22 and the top of the body 12B of the upper 12 to fit snugly around the leg of the dog. In tandem, the strap 14 and the cord 16 help to hold the shoe onto the dog's leg. Additionally, the strap 14 and cord 16 help create a watertight seal to prevent water from entering into the shoe 10. The cord 16 can be comprised of any desired material, such as an elastic bungie material. The cord 16 can be an elastic cord.

The cord 16 may include a tightening device 32, such as a stopper or depressible clip, for tightening and loosening the cord 16. The clip 32 mechanically locks a desired position of the cord 16. Accordingly, the clip 32 holds a desired tension of the cord 16 which thereby causes the upper 12 to grip onto the leg of the animal. The clip 32 can be positioned in front of the upper 12 and above of the strap 14. The clip 32 may rest on top of the strap 14. The clip 32 may comprise a biasing member, such as a spring. The clip 32 may comprise any desired material, such as plastic.

The cord 16 can additionally include an end tab 34 that is selectively connectable to the upper 12. Thereby, the cord 16 may be held in place such that it cannot be caught on or entangled by foreign objects. For example, the cord 16 can have a tab 34 with fastening features that engage with corresponding fastening features on the upper 12. The cord 16 can have a tab 34 with hooks, and the upper 12 can have a corresponding fastening element 36 for connecting with the tab 34. The fastening element 36, such as a Velcro® patch, may have loops for engaging with the hooks of the tab 34, or vice versa (FIG. 1). The fastening element 36 of the upper 12 may be located at the front of the body 12B of the upper 12. The tab 34 may additionally cover and couple the ends of the cord 16 together. The tab 34 can comprise any desired material, such as a fabric material.

The multilayer sole 18 comprises a first, upper outsole 38 and a second, lower outsole 40. The first and second outsoles 38, 40 comprise differing materials. The outsoles 38, 40 can correspond to one another in size and shape. The outsoles 38, 40 can assist in maintaining a watertight seal of the shoe 10.

The first outsole 38 is connected to the body 12B of the upper 12. In more detail, the top of the first outsole 38 is connected to and covers the bottom of the body 12B of the upper 12. The first outsole 38 can be fixed to the upper 12, for example, with an adhesive. The first outsole 38 comprises a first material, such as ethylene-vinyl acetate (EVA) foam. Due to the foam material of the first outsole 38, the first outsole 38 decreases the weight of the shoe 10 and helps to improve user comfort because it absorbs and transmutes the impact forces acting on the animal's foot. Hence, the EVA foam outsole 38 may serve as a shock absorber to protect the paws of the dog. Additionally, due to the foam material of the first outsole 38, the first outsole 38 seals and waterproofs the bottom of the upper 12.

The first outsole 38 has a top, front, back, sides, and bottom. The front, back, and side walls form a cavity. The shape and size of the first outsole 38 corresponds to the size and shape of the bottom of the body 12B of the upper 12 such that the first outsole 38 caps the bottom of the upper 12 (FIGS. 3 and 6). The back wall or portion may be taller than the front portion. The side profiles of the sides of the first outsole may be bulbous in shape (FIG. 3). Therein, the side profiles of the sides of the first outsole 38 may safeguard the upper 12 by preventing water and other elements from splashing upwardly on to the upper 12. Additionally, the side profiles create a larger, i.e., wider, bottom surface area if the shoe 10 sinks into the ground, for example when walking in mud or snow. The greater surface area helps to disperse the weight of the dog. Accordingly, the side profiles of the first outsole 38 help prevent the paws of the dog from getting stuck in mud or snow by dispersing the dog's weight.

The first outsole 38 may include a plurality of grooves 42. The grooves 42 can be configured for channeling water downwardly and away from the upper 12. The grooves 42 can be in the form of indents or cutouts in the sides of the first outsole 38. Each groove 42 may vary in depth and/or width throughout its length. The depth of each groove 42 may be approximately 3-8 mm, plus or minus 2 mm. The top end of each groove 42 may form an apex and the bottom end of each groove 42 may be open ended (FIGS. 1 and 4). The bottom end of each groove 42 may be flush with the sides of the second outsole 40. The grooves 42 may extend from the bottom surface of the first outsole 38 and into the sides of the first outsole 38. The grooves 42 may extend through the majority of the height of the sides of the first outsole 38. The grooves 42 may not extend the entire height of the sides. The grooves 42 may not be identical to one another. For instance, each groove 42 may differ from one another in size, shape, angle, depth, and/or location. Each groove 42 may have its own length and orientation for most efficiently directing water toward the ground.

The first outsole 38 may additionally include one or more side channels 44 on each of its lateral sides. Each side channel 44 may extend through the entire length of the sides. Each side channel 44 may have a differing width along its length. Therein, the top of each channel 44 may be wider than the bottom thereof. Each side channel 44 may be angled to downwardly and forwardly to direct water toward the ground. Each side channel 44 may be in the form of an indentation or cutout. The sides of the top opening of each channel 44 may be chamfered (FIG. 6). The depth of each channel 44 may be 3-20 mm, plus or minus 2 mm. Each side channel 44 may be located relative to a specific component and/or feature of the upper 12 in order to more efficiently direct water away from the upper 12. For instance, the sides channels 44 may be located adjacent to a stitching line SL of the upper 12 such that any water which would otherwise be caught or pooled on the upper 12 will instead be guided down the channels 44 toward the ground.

The second outsole 40 is connected to the first outsole 38. Particularly, the second outsole 40 is connected to the body 12B of the upper 12 and the first outsole 38. The second outsole 40 covers the bottom of the first outsole 38 and at least partially covers the body 12B of the upper 12. In more detail, the second outsole 40 is connected to and covers at least a portion of the front of the body 12B of the upper 12 and at least a portion of the back of the body 12B of the upper 12. The second outsole 40 can be fixed to the first outsole 38 and the upper 12, for example, with an adhesive. The second outsole 40 comprises a second material which is different than the first material of the first outsole 38. For example, the second outsole 40 can comprise an elastomeric polymer such as rubber.

The second outsole 40 has a top, front, back, sides, and bottom. The second outsole 40 comprises an upwardly curved front portion 40F, a flat middle portion 40M, and an upwardly curved back portion 40B (FIG. 6). The front portion 40F extends up and over and substantially covers the front portion of the first outsole 38. The front portion 40F also partially covers the front of the upper 12. The front portion 40F serves as a lip or front bumper. The middle portion 40M does not extend above or over the sides of the first outsole 38. The back portion 40B extends up and over and substantially covers the back portion of the first outsole 38. The back portion 40B also connects to and partially covers the back of the upper 12. The back portion 40B serves as a lip or back bumper. Thereby, the second outsole 40 covers and protects the front, back, and bottom of the first outsole 38. The second outsole 40 also covers and protects the front and back of the upper 12.

The second outsole 40 may additionally include one or more side channels 46 on each of its sides that corresponds to the one or more side channels 44 of the first outsole 38. The side channels 46 of the second outsole 40 may correspond in size, shape, and location of the side channels 44 of the first outsole 38. Each side channel 46 may extend through the height of the side of the second outsole 40. Each side channel 46 may have an angle that may or may not match the angle of the side channels 44 of the first outsole 38. The side channels 46 may have a differing width along their length. Therein, the top of each channel 46 may be wider than the bottom thereof.

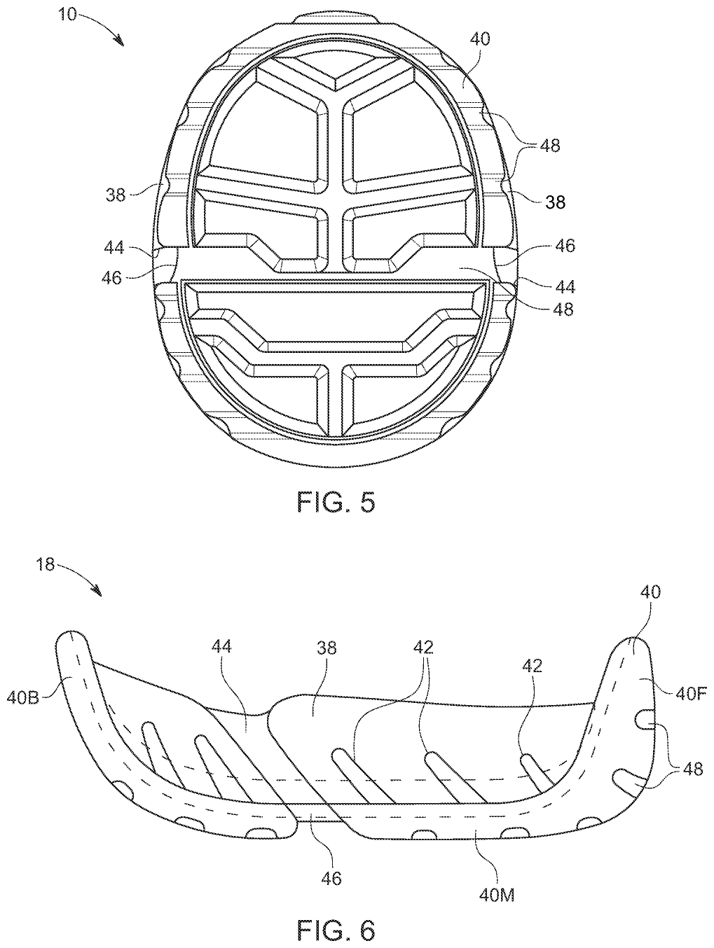

The bottom of the second outsole 40 may include a plurality of grooves 48 for augmenting traction. At least one groove 48 may correspond to and be in line with the side channels 44, 46 (FIG. 5). The grooves 48 may additionally assist in directing water away from the upper 12. The grooves 48 may differ from one another in size, shape, and location. The grooves 48 can be in the form of indents or cutouts. The depth of each groove 48 may be approximately 3-10 mm, plus or minus 2 mm.

Other embodiments, which differ from the aforementioned embodiments, may be recognized by those skilled in the art without departing from the scope of the following claims.

1. An animal shoe, comprising:
an upper comprising a body with an opening that is configured for receiving a foot of an animal; and
a multilayer sole comprising:
a first outsole connected to the body of the upper, the first outsole comprising a bottom, and the first outsole comprising a first material; and
a second outsole connected to the first outsole, the second outsole covering the bottom of the first outsole, the second outsole comprising a second material different than the first material of the first outsole.

2. The animal shoe of claim 1, wherein the first material of the first outsole is ethylene-vinyl acetate (EVA) foam, and the second material of the second outsole is an elastomeric polymer.

3. The animal shoe of claim 1, wherein the upper and the multilayer sole together form a watertight seal around the foot of the animal.

4. The animal shoe of claim 1, wherein body of the upper comprises a front, a back, a bottom, and sides, and wherein the first outsole is connected to and covers the bottom of the body of the upper.

5. The animal shoe of claim 4, wherein the second outsole is further connected to and covers at least a portion of the front of the body of the upper and at least a portion of the back of the body of the upper.

6. The animal shoe of claim 1, wherein the first outsole comprises a plurality of grooves.

7. The animal shoe of claim 1, wherein the second outsole comprises an upwardly curved front portion, a flat middle portion, and an upwardly curved back portion.

8. The animal shoe of claim 1, wherein the first outsole comprises one or more first side channels, and wherein the second outsole comprises one or more second side channels that correspond to the one or more first side channels of the first outsole.

9. The animal shoe of claim 1, wherein the upper further comprises a wraparound strap with hook and loop fasteners, the wraparound strap configured for applying a first holding force for holding the upper onto the foot of the animal.

10. The animal shoe of claim 1, wherein the upper further comprises an elastic cord at least partially extending within the body of the upper, the elastic cord configured for applying a second holding force for holding the upper onto the foot of the animal.

11. The animal shoe of claim 1, wherein the upper further comprises a tongue configured for widening and/or narrowing the opening of the body.

12. A dog shoe, comprising:
an upper comprising a body with an opening that is configured for receiving a paw of a dog;
a strap connected to the upper configured for holding the upper onto the paw of the dog; and
a multilayer sole comprising:
a first outsole connected to the body of the upper, the first outsole comprising a bottom, and the first outsole comprising a first material; and
a second outsole connected to the first outsole, the second outsole covering the bottom of the first outsole, the second outsole comprising a second material different than the first material of the first outsole.

13. The dog shoe of claim 12, wherein the first material of the first outsole is ethylene-vinyl acetate (EVA) foam, and the second material of the second outsole is an elastomeric polymer.

14. The dog shoe of claim 12, wherein the upper and the multilayer sole together form a watertight seal around the paw of the dog.

15. The dog shoe of claim 12, wherein body of the upper comprises a front, a back, a bottom, and sides, and wherein the first outsole is connected to and covers the bottom of the body of the upper.

16. The dog shoe of claim 15, wherein the second outsole is further connected to and covers at least a portion of the front of the body of the upper and at least a portion of the back of the body of the upper.

17. The dog shoe of claim 12, wherein the first outsole comprises a plurality of grooves.

18. The dog shoe of claim 12, wherein the second outsole comprises an upwardly curved front portion, a flat middle portion, and an upwardly curved back portion.

19. The dog shoe of claim 12, wherein the first outsole comprises one or more first side channels, and wherein the second outsole comprises one or more second side channels that correspond to the one or more first side channels of the first outsole.

20. The dog shoe of claim 12, wherein the upper further comprises a tongue configured for widening and/or narrowing the opening of the body.
